(19) United States
(12) Patent Application Publication
(10) Pub. No.: US 2026/0245148 A1
(43) Pub. Date: Aug. 20, 2026

(54) DISPLAY OF COMMUNICATED DATA ELEMENTS AND POSTS OF LIMITED DISPLAY SCREENS

(71) Applicant: Dunamu Inc., Seoul (KR)

(72) Inventors: Jihoon Lim, Seoul (KR); Kunsup Song, Seoul (KR); Grace Yang, Seoul (KR)

(21) Appl. No.: 19/332,853

(22) Filed: Sep. 18, 2025

(30) Foreign Application Priority Data
Feb. 19, 2025 (KR) 10-2025-0021463

(51) Int. Cl. G06Q 40/04; G06Q 40/06

(52) U.S. Cl. CPC G06Q 40/0431; G06Q 40/042; G06Q 40/064

(57) ABSTRACT

The present disclosure relates to a method for supporting analysis, display, and/or interaction with complex real-time data items, particularly in view of the limited display functionality of some computing devices. The method comprises: acquiring information on a first chart associated with a specific data item, the information on the first chart comprising information associated with a real-time data for the specific data item; generating, based on the information on the first chart, the first chart that comprises at least one of value-fluctuation information of the specific data item for a current time and a period before the current time, or information associated with the real-time data for a period after the current time, and outputting the first chart as at least part of a user interface.

### CROSS-REFERENCE TO RELATED APPLICATION

The present application claims priority to and the benefit of Korean Application No. 10-2025-0021463, filed on Feb. 19, 2025, in the Korean Intellectual Property Office, the entire disclosure of which is incorporated by reference herein.

### BACKGROUND

### Field

The present disclosure relates to a method and an apparatus for data processing and display of complex data structures on user interfaces.

### Description of the Related Art

An increasing amount of complex work is done using computing devices (e.g., mobile phones) with relatively limited display screens. For example, users might perform complex data analysis tasks and/or make major life decisions using a relatively small screen that can only display a limited amount of information at once. This can be particularly cumbersome in the context of processes that require analysis of real-time, complex data, as it can be practically quite difficult for users to analyze that data (particularly given how quickly it moves/changes) on a limited display screen. That difficulty becomes even more attenuated when that data is to be correlated with additional information, such as online news articles and similar lengthy content.

### SUMMARY

At least some aspects of the subject matter disclosed herein provide technology that effectively furnishes information about complex real-time data items, so that the user may easily monitor the complex real-time data items even when limited by the simple display screen of (for example) a smartphone.

At least some aspects of the subject matter disclosed herein provide technology that effectively furnishes information about online activity (e.g., news, online chat, forum posts) associated with complex real-time data items.

The present disclosure provides a method, a recording medium storing a computer program, and a device (system) for supporting analysis, display, and/or interaction with complex real-time data items.

The technical problems of the subject matter disclosed herein are not limited to the technical problems mentioned above, and other technical problems not mentioned will be clearly understood by those skilled in the art from the description below.

The present disclosure may be implemented in various forms, including a method, a system (device), or a computer-readable storage medium storing a computer program.

In some examples, a method for supporting analysis, display, and/or interaction with complex real-time data items, the method may include, being performed by at least one processor acquiring information on a first chart associated with a specific data item, the information on the first chart may include information associated with real-time data for the specific data item, generating the first chart based on the information on the first chart, the first chart may include at least one of value-fluctuation information of the specific data item for a current time and a period before the current time, or information associated with the real-time data for a period after the current time, and outputting the first chart as at least part of a user interface, wherein the information associated with the real-time data may include at least one of information on real-time data associated with a user with respect to the specific data item or information on posts associated with a real-time data for the specific data item.

In some examples, a first axis of the first chart represents time information and a second axis of the first chart represents value information of the specific data item, and the generating the first chart may include mapping information on the held real-time data to a position corresponding to expiration-date information of the held real-time data on the first axis and value information of the held real-time data for the specific data item on the second axis.

In some examples, the generating the first chart may further include mapping information on a value range of the held real-time data onto the first chart.

In some examples, the mapping the information on the value range may include identifying, on the second axis, a first value of the specific data item corresponding to a value correspondence point of the held real-time data, and the first chart may include a first region corresponding to a value higher than the first value and a second region corresponding to a value lower than the first value and distinguished from the first region.

In some examples, the generating the first chart may further include mapping information on expected value of the real-time data onto the first chart.

In some examples, the mapping of the information on the expected value may include identifying expected value anticipated on an expiration date of the real-time data, the expected value being calculated based on a second value of the specific data item, the first chart may include a region in which information on the identified expected value is displayed, and the second value is a value of the specific data item at a time of calculating the expected value of the held real-time data.

In some examples, the method further includes generating a second chart representing value-fluctuation information of a real-time data for the specific data item, and outputting the generated second chart as at least part of the user interface in a position adjacent to the first chart, wherein a first axis of the first chart represents time information, a second axis of the first chart represents value information of the specific data item, a third axis of the second chart represents time information, and a fourth axis of the second chart represents value information of the real-time data for the specific data item.

In some examples, a time range on the first axis of the first chart may be identical to a time range on the third axis of the second chart and the first chart and the second chart represent information of the same time range.

In some examples, a first axis of the first chart may represent time information and a second axis of the first chart may represent value information of the specific data item, and the generating the first chart may include, in response to receiving an input registering a post targeting specific time information among a plurality of items of time information on the first axis, mapping information on the registered post to the specific time information on the first chart.

In some examples, the input registering the post targeting the specific time information may include selecting the specific time information among the plurality of items of time information on the first axis and inputting registration of a post corresponding to the selected specific time information.

In some examples, the specific time information may be identified based on the registered post.

In some examples, a first axis of the first chart represents time information and a second axis of the first chart represents value information of the specific data item, and the generating the first chart may include mapping, onto the first chart, information on a plurality of posts, each targeting respective items of the time information on the first axis.

In some examples, the method further includes, in response to receiving an input selecting specific time information among the plurality of items of time information on the first axis, outputting, as at least part of the user interface, posts targeting the specific time information.

In some examples, the information on the plurality of posts may include information on a number of posts targeting each of the plurality of items of time information, and the mapping of the information on the plurality of posts onto the first chart may include mapping the information on the number of posts onto the first chart so that the information on the number of posts is visually displayed at positions corresponding to each of the plurality of items of time information on the first chart.

In some examples, the information on the plurality of posts may further include at least one of category information of each of the plurality of posts or value-fluctuation prediction information of the specific data item associated with each of the plurality of posts.

In some examples, the information associated with the real-time data may further include information on a real-time data registered by the user with respect to the specific data item, and the generating the first chart may include mapping the information on the real-time data onto the first chart.

In some examples, a first axis of the first chart represents time information and a second axis of the first chart represents value information of the specific data item, and the mapping the information on the interest-real-time data may include mapping the information on the interest-real-time data to a position corresponding to expiration-date information of the interest-real-time data on the first axis and value information of the interest-real-time data for the specific data item on the second axis.

In some examples, the information associated with the real-time data may further include value-alert information registered by the user with respect to the specific data item, a first axis of the first chart represents time information and a second axis of the first chart represents value information of the specific data item, and the generating the first chart may include identifying, on the second axis of the first chart, a third value corresponding to the value-alert information, and a position corresponding to the third value is displayed in the first chart.

In some examples, a non-transitory computer-readable recording medium storing a computer program for executing the above-mentioned method on a computer.

In some examples, a computing device for supporting analysis, display, and/or interaction with complex real-time data items, may include a memory, and at least one processor connected to the memory and configured to execute at least one computer-readable program included in the memory, wherein the at least one program may include instructions to acquire information on a first chart associated with a specific data item, generate the first chart based on the information on the first chart, and output the first chart as at least part of a user interface, wherein the information on the first chart may include information associated with a real-time data for the specific data item, the first chart may include at least one of value-fluctuation information of the specific data item for a current time and a period before the current time or information associated with the real-time data for a period after the current time, and the information associated with the real-time data may include at least one of information on a held real-time data that a user holds with respect to the specific data item or information on posts associated with a real-time data for the specific data item.

In some examples of the present disclosure, one technical effect is that a graph representing time-based value fluctuation of the specific data item and information on a held real-time data that the user holds may be mapped onto a single chart. Accordingly, the user may intuitively compare a value trend of the specific data item and value information of the held real-time data without switching or leaving a screen, which may improve user convenience.

In some examples of the present disclosure, one technical effect is that, along with outputting a graph representing time-based value fluctuation of the specific data item, information on expected value of the held real-time data may be output or value and ranges of the held real-time data may be displayed distinctly. Accordingly, the user may readily monitor information on the held real-time data and user convenience may be improved.

In some examples of the present disclosure, one technical effect is that a first chart representing value-fluctuation information of the specific data item and a second chart representing value-fluctuation information of a real-time data for the specific data item may be output on a single screen. Accordingly, the user may easily compare value-fluctuation information of the specific data item with value-fluctuation information of the real-time data for the asset without switching or leaving a screen.

In some examples of the present disclosure, a technical effect is that the first chart representing value-fluctuation information of the specific data item and the second chart representing value-fluctuation information of a real-time data for the specific data item may be output in adjacent positions and synchronized based on a common time axis. Accordingly, the user may readily grasp value-fluctuation trends for the specific data item and a real-time data associated with the specific data item during the same time period.

In some examples of the present disclosure, a technical effect is that information on posts mapped to the first chart representing value-fluctuation information of the specific data item may be provided and comparative information on numbers of posts mapped by time point may be provided. Accordingly, the user may grasp time points of high user interest concerning the value fluctuation of the specific data item and may check information on posts corresponding to such time points, thereby obtaining assistance in monitoring the specific data item or the held real-time data.

In some examples of the present disclosure, a technical effect is that posts shared by multiple users may be filtered and provided by time information targeted by each post. Accordingly, the user may easily browse posts corresponding to time information of interest.

Effects of the present disclosure are not limited to those mentioned above, and other effects not mentioned will be clearly understood by those skilled in the art from the scope of the claims.

### BRIEF DESCRIPTION OF DRAWINGS

Examples of the present disclosure will now be described with reference to the attached drawings, wherein like reference numerals designate like elements, without limitation thereto.

FIG. 1 is a diagram illustrating an example of a user interface for supporting analysis, display, and/or interaction with complex real-time data items.

FIG. 2 is a block diagram illustrating an example in which an information-processing system is connected so as to be able to communicate with multiple user terminals to provide a service supporting analysis, display, and/or interaction with complex real-time data items.

FIG. 3 is a block diagram illustrating an example of internal configurations of a user terminal and an information-processing system.

FIG. 4 is a diagram illustrating an example of a user interface for selecting a particular underlying-asset symbol among underlying-asset symbols associated with complex real-time data items that the user holds.

FIG. 5 is a diagram illustrating an example in which a first chart representing information associated with a real-time data is output.

FIG. 6 is a diagram illustrating an example in which information on a value range or expected value of a held real-time data is mapped onto the first chart.

FIG. 7 is a diagram illustrating an example of a user interface in which the first chart and a second chart are output.

FIG. 8 is a diagram illustrating an example of a user interface in which information on a plurality of posts associated with a specific data item is output.

FIG. 9 is a diagram illustrating an example in which information on posts associated with specific time information is output.

FIG. 10 is a block diagram for explaining an example in which information on posts is extracted from posts.

FIG. 11 is a flowchart illustrating a method for supporting analysis, display, and/or interaction with complex real-time data items.

### DETAILED DESCRIPTION

Hereinafter, specific details for implementing examples of the present disclosure will be described in detail with reference to the accompanying drawings. However, in the following description, detailed descriptions of well-known functions or configurations will be omitted when it is determined that such descriptions may unnecessarily obscure the gist of the present disclosure.

In the attached drawings, the same or corresponding components are assigned the same reference numerals. In the following description of examples, descriptions of the same or corresponding components may be omitted to avoid redundancy. Nevertheless, omission of a description of a component does not mean that such component is not included in an example.

Advantages, features, and methods for achieving them according to the disclosed examples will become apparent from the examples described below with reference to the accompanying drawings. However, the present disclosure is not limited to the examples disclosed below and may be implemented in various different forms. The examples are provided merely to make the present disclosure complete and to fully inform those skilled in the art of the scope of the invention.

Singular expressions in the present specification include plural expressions unless clearly specified otherwise by context. Likewise, plural expressions include singular expressions unless clearly specified otherwise by context. Throughout the specification, when a part is described as including an element, the part may further include other elements unless specifically stated otherwise.

Further, the terms “module” or “unit” used in the specification refer to software or hardware components that perform specified roles. “Module” or “unit” is not limited to software or hardware. A “module” or “unit” may be configured so as to reside on an addressable storage medium or to be executable by one or more processors. Accordingly, a “module” or “unit” may include at least one of software components, object-oriented software components, class components, task components, processes, functions, attributes, procedures, subroutines, program-code segments, drivers, firmware, microcode, circuits, data, databases, data structures, tables, arrays, or variables. The functions provided by components and “modules” or “units” may be combined into a smaller number of components and “modules” or “units” or further separated into additional components and “modules” or “units.”

According to an example of the present disclosure, a “module” or “unit” may be implemented by a processor and a memory. The “processor” should be broadly construed to include a general-purpose processor, a central processing unit (CPU), a microprocessor, a digital signal processor (DSP), a controller, a microcontroller, or a state machine. In some environments, the “processor” may denote an application-specific integrated circuit (ASIC), a programmable logic device (PLD), or a field-programmable gate array (FPGA). The “processor” may also denote a combination of processing devices such as a combination of a DSP and a microprocessor, a combination of multiple microprocessors, a combination of one or more microprocessors combined with a DSP core, or any other such configuration. The “memory” should be broadly construed to include any electronic component capable of storing electronic information. The “memory” may denote various types of processor-readable media such as random-access memory (RAM), read-only memory (ROM), non-volatile RAM (NVRAM), programmable ROM (PROM), erasable PROM (EPROM), electrically erasable PROM (EEPROM), flash memory, magnetic or optical data storage devices, or registers. If a processor may read information from or write information to a memory, the memory is said to be in electronic communication with the processor. A memory integrated in a processor is in electronic communication with the processor.

In the present disclosure, a “system” may include at least one device among a server device and a cloud device but is not limited thereto. For example, the system may be configured of one or more server devices. As another example, the system may be configured of one or more cloud devices. As yet another example, the system may be configured so that server devices and cloud devices operate together.

In the following examples, terms such as first, second, A, B, (a), or (b) are used only to distinguish one component from another component, and the terms do not limit the nature, order, or sequence of the components.

In the following examples, when a component is described as being “connected,” “coupled,” and/or “linked” to another component, the component may be directly connected or coupled to that other component or there may be another component “connected,” “coupled,” and/or “linked” between the components.

Further, the terms “include” or “comprise” used in the following examples do not exclude the presence or addition of one or more other components, steps, operations, or elements apart from the stated components, steps, operations, or elements.

In the present disclosure, “each of a plurality of A” may refer to each of all components included in the plurality of A or to each of some of the components included in the plurality of A.

In the present disclosure, unless stated otherwise, “or” should be understood as allowing all combinations of a plurality of elements connected by “or.” For example, “A or B” may include “A,” “B,” and “A and B,” and “A, B, or C” may include “A,” “B,” “C,” “A and B,” “B and C,” “A and C,” and “A, B, and C.”

Before describing various examples of the present disclosure, terms used will be described.

In the present disclosure, “information associated with X” and “X information” may be used interchangeably with the same meaning.

In the present disclosure, a “user” may denote a user who uses a service provided based on various examples of the present disclosure, such as a service supporting analysis, display, and/or interaction with complex real-time data items.

In the present disclosure, an “data item” may denote various asset classes existing in financial markets. Specific examples of the data item may include assets such as stocks, bonds, currencies, commodities, or cryptocurrencies.

In the present disclosure, a “user interface” is not limited to a single screen displayed on a display of a user terminal, etc., and may denote one or more screens including windows, icons, buttons, or menus so that a user may receive information or interact. The specific configuration of the user interface illustrated in each drawing is merely exemplary for description and is not limited thereto. For example, arbitrary graphic objects or graphic elements different from those illustrated may be used.

Various examples of the present disclosure will now be described in detail with reference to the attached drawings.

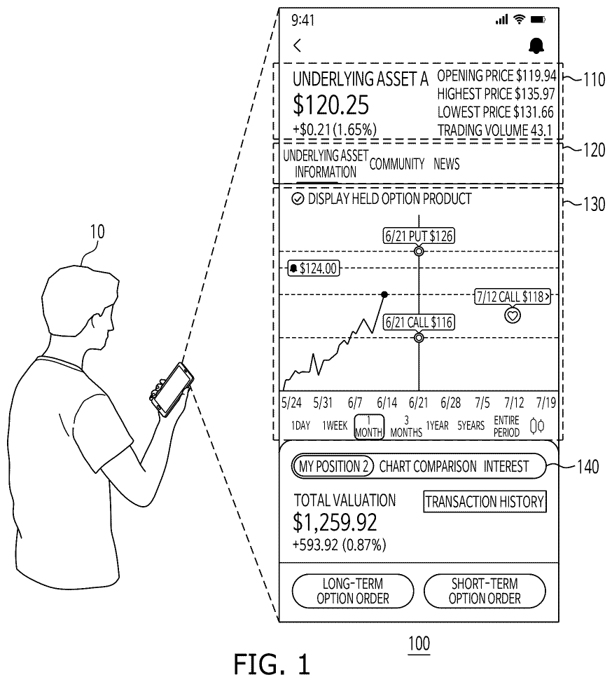

FIG. 1 is a diagram illustrating an example of a user interface 100 for supporting analysis, display, and/or interaction with complex real-time data items. Through the user interface 100, a user 10 who uses a service supporting analysis, display, and/or interaction with complex real-time data items may retrieve information associated with a real-time data for a specific data item. A processor (e.g., at least one processor of a user terminal) may output, as at least part of the user interface, information associated with a real-time data for the specific data item.

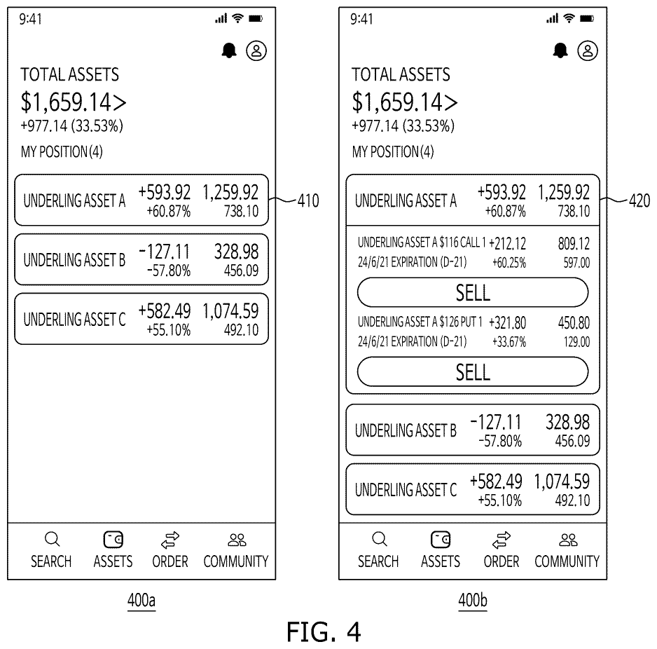

In an example, the user 10 may select a specific data item for which the user intends to retrieve information associated with a real-time data. The specific data item may be at least one identifier associated with complex real-time data items that the user 10 is associated with, but is not limited thereto. For example, the processor may output, as at least part of the user interface, a list of identifiers associated with complex real-time data items that the user 10 is associated with. In response to receiving an input of the user 10 selecting at least one symbol from the list, the processor may output, as at least part of the user interface 100, information associated with a real-time data for the selected identifier. An example of a user interface for receiving the user input selecting the specific data item is described in detail with reference to FIG. 4.

Through the user interface 100, the user 10 may retrieve basic information on the specific data item. For example, the processor may output, in a first area 110 of the user interface 100, basic information on the specific data item for which the user wishes to retrieve information associated with a real-time data. The basic information on the specific data item may include the identifier name, current value, value change rate, opening value, highest value, lowest value, volume, and the like of the specific data item, but is not limited thereto.

Through the user interface 100, the user 10 may retrieve information associated with a real-time data for the specific data item. The information associated with the real-time data may include at least one of information on a held real-time data that the user holds with respect to the specific data item or information on posts associated with a real-time data for the specific data item. Additionally, the information associated with the real-time data may further include information on an interest-real-time data registered by the user with respect to the specific data item or value-alert information registered by the user with respect to the specific data item, but is not limited thereto.

Information associated with the real-time data for the specific data item may be provided in the form of a chart. For example, the processor may acquire information on a first chart. The information on the first chart may include information associated with a real-time data for the specific data item. Then, the processor may generate the first chart based on the information on the first chart. Additionally, the processor may output the generated first chart as at least part of the user interface 100. As illustrated in FIG. 1, the first chart may be output in a second area 130 of the user interface 100, but is not limited thereto.

In an example, the first chart may include value-fluctuation information of the specific data item for the current time and a period before the current time. Additionally or alternatively, the first chart may include information associated with a real-time data for a period after the current time. That is, the first chart may provide different information for the period before the current time and the period after the current time with the current time as a reference point. Further, when the first chart includes information for the current time, for the period before the current time, and for the period after the current time, a time axis (e.g., a horizontal axis of the first chart) of the first chart may represent a flow of continuous time connected with the current time as the reference point.

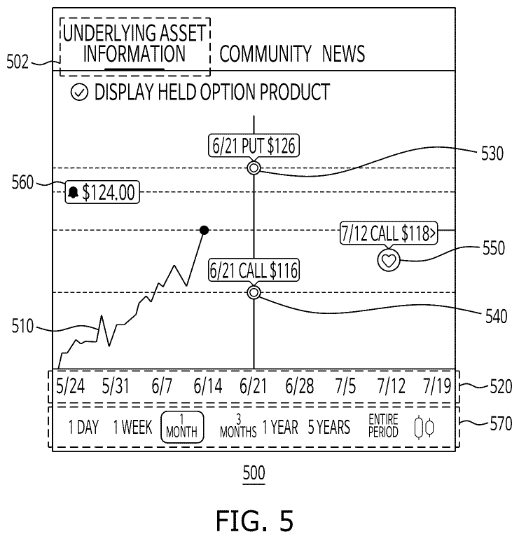

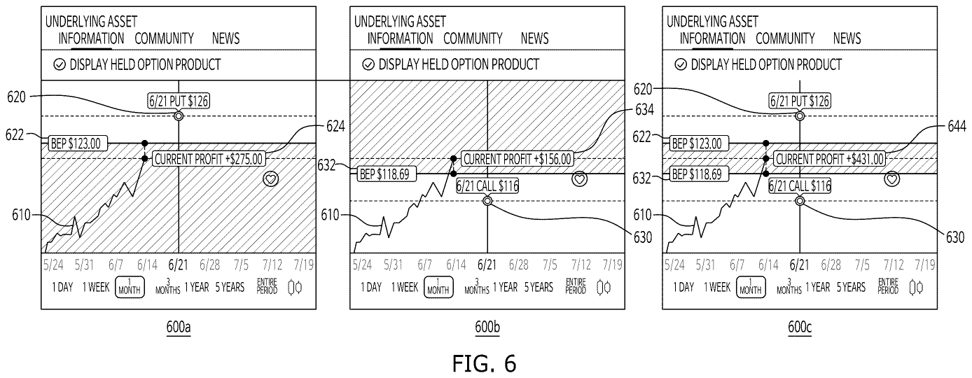

In an example, information on the held real-time data may be mapped onto the first chart. For example, the processor may map information on the held real-time data onto the first chart, and the first chart with the information on the held real-time data mapped may be output as at least part of the user interface 100. In an example, the first chart in which information on the held real-time data is mapped may include value-fluctuation information of the specific data item for the current time and the period before the current time and information associated with a real-time data for the period after the current time. In this case, information associated with a real-time data expiring at a time after the current time may be mapped onto the first chart. Examples of the first chart including information on the held real-time data are described in detail with reference to FIGS. 5 and 6.

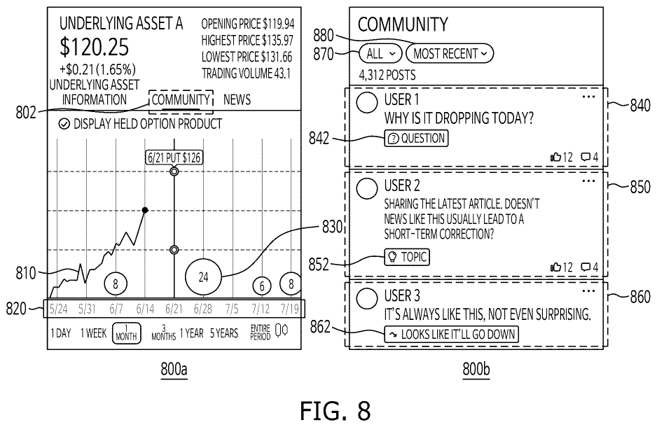

In an example, information on posts associated with a real-time data for the specific data item may be mapped onto the first chart. For example, the processor may map information on posts associated with a real-time data onto the first chart, and the first chart with the information on posts associated with a real-time data mapped may be output as at least part of the user interface 100. In an example, the first chart in which information on posts associated with a real-time data is mapped may include value-fluctuation information of the specific data item for the current time and the period before the current time and information associated with a real-time data for the period after the current time. In this case, information on plurality of posts targeting a time after the current time may be mapped onto the first chart. Examples of the first chart including information on posts associated with a real-time data are described in detail with reference to FIGS. 8 through 10.

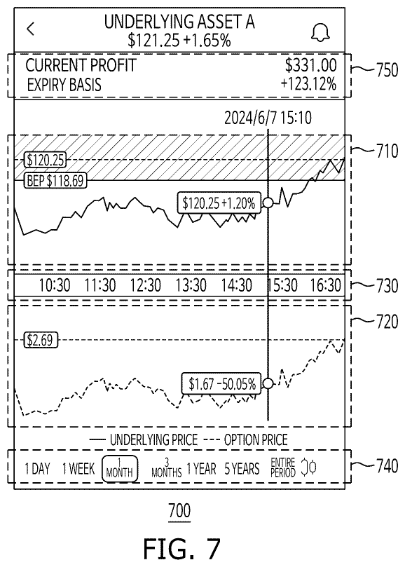

Through the user interface 100, the user 10 may retrieve value-fluctuation information of the specific data item and/or value-fluctuation information of a real-time data for the specific data item. For example, the processor may output, as at least part of the user interface 100, a first chart including value-fluctuation information of the specific data item and a second chart representing value-fluctuation information of the real-time data. In this case, the first chart and the second chart may be output in adjacent positions on the user interface 100. In an example, the first chart including information associated with a real-time data may include value-fluctuation information of the specific data item for the current time and the period before the current time. Examples of the first chart and the second chart being output are described in detail with reference to FIG. 7.

In an example, the user 10 may select types of information associated with a real-time data output as at least part of the user interface 100 through a first tab area 120 and/or a second tab area 140. The processor may output information associated with a real-time data corresponding to a selected type as at least part of the user interface 100.

In a concrete example, in response to receiving a user's input selecting a “data item information” tab of the first tab area 120, the processor may output a first chart including information on the real-time data in a second area 130 of the user interface 100.

As another example, in response to receiving a user's input selecting a “community” tab of the first tab area 120, the processor may output a first chart including information on posts associated with a real-time data in the second area 130 of the user interface 100.

As yet another example, in response to receiving a user's input selecting a “chart comparison” tab of the second tab area 140, the processor may output, as at least part of the user interface 100, a first chart including information associated with a real-time data and a second chart including value-fluctuation information of the specific data item.

Additionally, the user 10 may retrieve, by selecting at least one tab of the first tab area 120 or the second tab area 140, information on news associated with the specific data item, detailed information on the real-time data that the user is associated with with respect to the specific data item, information on the interest-real-time data registered by the user, and the like. Types of information associated with a real-time data configured in the first tab area 120 and the second tab area 140 of FIG. 1 are merely exemplary and are not limited thereto.

In FIG. 1, the first area 110, the first tab area 120, the second area 130, and the second tab area 140 are illustrated as being output in mutually separated areas on the user interface 100; however, a relative structure or relative position of each area may vary depending on design of the user interface 100.

In an example, the real-time data items may include option products, and the data item may include an underlying asset. Examples in which information associated with option products for a specific underlying asset are displayed on user interfaces are described in more detail with reference to FIGS. 4 to 7.

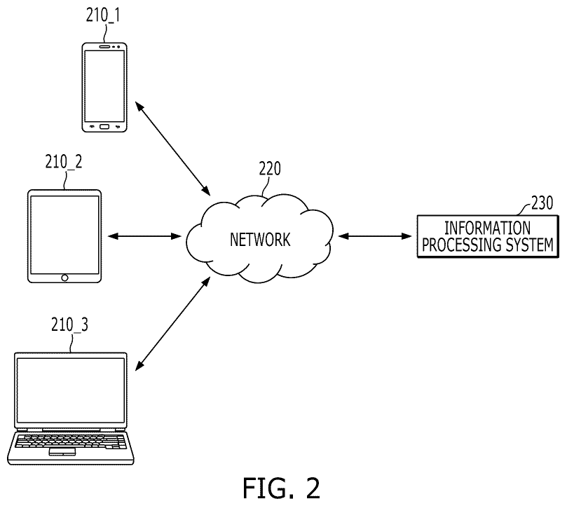

FIG. 2 is a conceptual diagram illustrating an example in which an information-processing system 230 is connected so as to be able to communicate with a plurality of user terminals 212, 214, 216 to provide a service supporting analysis, display, and/or interaction with complex real-time data items. The information-processing system 230 may include systems capable of providing a service supporting analysis, display, and/or interaction with complex real-time data items.

In an example, the information-processing system 230 may include one or more server devices or one or more distributed-computing devices based on a cloud computing service that may store, provide, and execute computer-executable programs (downloadable applications, etc.) and data related to a service supporting analysis, display, and/or interaction with complex real-time data items. Additionally, the information-processing system may include or be configured so as to be communicable with any database (not shown) related to a service supporting analysis, display, and/or interaction with complex real-time data items.

A service supporting analysis, display, and/or interaction with complex real-time data items provided by the information-processing system 230 may be provided to users through applications installed on respective user terminals 212, 214, 216. In this case, the service supporting analysis, display, and/or interaction with complex real-time data items may denote a service that provides information associated with a real-time data for a specific data item.

The plurality of user terminals 212, 214, 216 may communicate with the information-processing system 230 through a network 220. The network 220 may be configured so as to enable communication between the plurality of user terminals 212, 214, 216 and the information-processing system 230. Depending on installation environments, the network 220 may be configured as a wired network such as Ethernet, wired home network (power-line communication), telephone-line communication, or RS-serial communication, a wireless network such as a mobile-communication network, WLAN, Wi-Fi, Bluetooth, or ZigBee, or a combination thereof. The communication method is not limited, and the network 220 may include near-field wireless communication among the user terminals 212, 214, 216 as well as communication methods utilizing communication networks (a mobile-communication network, a wired Internet, a wireless Internet, a broadcasting network, or a satellite network) that the network 220 may include.

The plurality of user terminals 212, 214, 216 may transmit requests through the network 220 to the information-processing system 230, and after receiving the requests, the information-processing system 230 may transmit responses corresponding to the requests to the plurality of user terminals 212, 214, 216.

For example, when information on a specific data item selected among identifiers associated with complex real-time data items that the user holds is transmitted from the user terminals 212, 214, 216 to the information-processing system 230 through user input at the user terminals 212, 214, 216, the information-processing system 230 may transmit information associated with a real-time data for the selected specific data item to the user terminals 212, 214, 216. The user terminals 212, 214, 216 may generate a chart based on the information associated with a real-time data and output the generated chart as at least part of a user interface. Additionally, the user terminals 212, 214, 216 may generate a chart in which information on a held real-time data that the user holds and/or information on posts associated with a real-time data for the specific data item are mapped based on the information associated with a real-time data, and may output the generated chart as at least part of the user interface.

In another example, the information-processing system 230 may receive, through user input at the user terminals 212, 214, 216, information on a specific data item for which the user wishes to receive information on a real-time data, and may generate a chart in which information associated with a plurality of complex real-time data items corresponding to the received information on the specific data item and/or information on a held real-time data that the user holds with respect to the specific data item are mapped, and may transmit the generated chart to the user terminals 212, 214, 216. The user terminals 212, 214, 216 may output the chart received from the information-processing system 230 as at least part of a user interface.

However, the example in which the user terminals 212, 214, 216 generate and output a chart in which information associated with a real-time data is mapped through communication with the information-processing system 230 is not limited thereto. For example, the user terminals 212, 214, 216 may transmit at least part of information associated with a real-time data to the information-processing system 230, and the information-processing system 230 may generate a chart including information associated with a real-time data by using at least part of the received information associated with a real-time data and information stored in the information-processing system 230 in advance. Thereafter, the user terminals 212, 214, 216 may receive the generated chart from the information-processing system 230 and output the received chart as at least part of a user interface. Alternatively, the user terminals 212, 214, 216 may receive at least part of information associated with a real-time data from the information-processing system 230, and may generate a chart in which information associated with a real-time data is mapped by using at least part of the received information associated with a real-time data, information directly received through user input at the user terminals 212, 214, 216, or information stored in the user terminals 212, 214, 216 in advance. Additionally, the user terminals 212, 214, 216 may generate a chart in which information associated with a real-time data is mapped by using information directly received through user input at the user terminals 212, 214, 216 or information stored in the user terminals 212, 214, 216 in advance without receiving information via the information-processing system 230. Thereafter, the user terminals 212, 214, 216 may output the generated chart as at least part of a user interface.

In FIG. 2, a mobile-phone terminal 212, a tablet terminal 214, and a PC terminal 216 are illustrated as examples of user terminals; however, the user terminals 212, 214, 216 are not limited thereto and may be any computing devices capable of wired or wireless communication and executing an application, etc. For example, the user terminals may include a smartphone, a mobile phone, a navigation device, a computer, a laptop, a digital-broadcast terminal, a PDA, a PMP, a tablet PC, a game console, a wearable device, an IoT device, a VR device, or an AR device. Further, although three user terminals 212, 214, 216 are illustrated as communicating with the information-processing system 230 through the network 220, the number of user terminals communicating with the information-processing system 230 through the network 220 may vary.

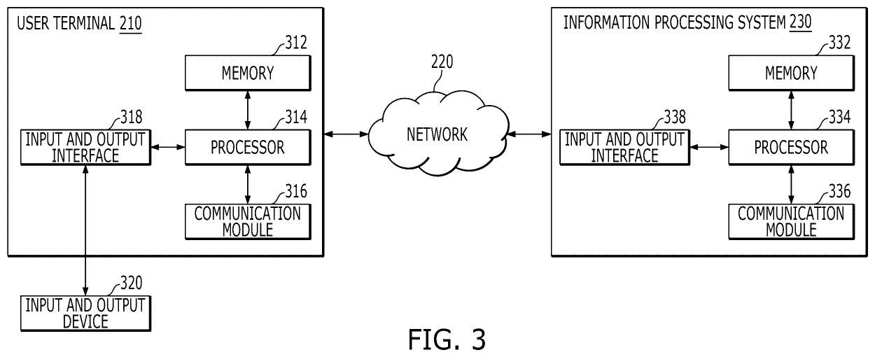

FIG. 3 is a block diagram illustrating an example of internal configurations of a user terminal 210 and the information-processing system 230. The user terminal 210 may denote any computing device capable of executing an application, etc., that retrieves and outputs information associated with a real-time data for a specific data item and capable of wired/wireless communication, and may include, for example, the mobile-phone terminal 212, the tablet terminal 214, or the PC terminal 216 of FIG. 2. As illustrated, the user terminal 210 may include a memory 312, a processor 314, a communication interface 316, and an input/output interface 318. Similarly, the information-processing system 230 may include a memory 332, a processor 334, a communication interface 336, and an input/output interface 338. Further, an input/output device 320 may be configured so as to input information or data to the user terminal 210 or output information or data generated by the user terminal 210 through the input/output interface 318.

As illustrated in FIG. 3, the user terminal 210 and the information-processing system 230 may be configured so as to communicate information or data through the network 220 by using respective communication interfaces 316, 336.

The memories 312, 332 may include non-transitory computer-readable recording media. In an example, the memories 312, 332 may include permanent mass-storage devices such as ROM, disc drives, SSDs, or flash memories. In another example, permanent mass-storage devices such as ROM, SSDs, flash memories, or disc drives may be included in the user terminal 210 or the information-processing system 230 as separate permanent storage devices distinct from the memories. Further, the memories 312, 332 may store an operating system and at least one program code (e.g., code for an application that retrieves information associated with a real-time data for a specific data item, generates a chart including information associated with the real-time data, and outputs the generated chart).

Such software components may be loaded from computer-readable recording media separate from the memories 312, 332. Such separate computer-readable recording media may include recording media directly connectable to the user terminal 210 or the information-processing system 230, for example, floppy drives, discs, tapes, DVD/CD-ROM drives, USB memories, or memory cards. As another example, the software components may be loaded into the memories 312, 332 through the communication interfaces 316, 336. For example, the at least one program may be installed into the memories 312, 332 based on files provided by developers or by a file-distribution system distributing installation files of applications through the network 220 (e.g., an application that retrieves information associated with a real-time data for a specific data item, generates a chart including information associated with the real-time data, and outputs the generated chart).

The processors 314, 334 may be configured so as to process instructions by performing basic arithmetic, logic, and input/output operations, thereby executing commands of computer programs. Commands may be provided to the processors 314, 334 through the memories 312, 332 or the communication interfaces 316, 336. For example, the processors 314, 334 may be configured so as to execute commands received in accordance with program code stored in the memories 312, 332 as recording devices.

The communication interfaces 316, 336 may provide configurations or functions for communication between the user terminal 210 and the information-processing system 230 through the network 220, and may provide configurations or functions for communication between the user terminal 210 or the information-processing system 230 and another user terminal or another system (a separate cloud system, etc.). Requests or data generated in accordance with program code stored in a recording device such as the memory 312 may be transmitted through the network 220 to the information-processing system 230 under control of the communication interface 316. Conversely, control signals or commands provided under control of the processor 334 of the information-processing system 230 may be received by the user terminal 210 through the communication interface 316 via the communication interface 336 and the network 220.

The input/output interface 318 may be means for interfacing with the input/output device 320. As an example, the input device may include devices such as a camera including an audio sensor or an image sensor, a keyboard, a microphone, or a mouse, and the output device may include devices such as a display, a speaker, or a haptic-feedback device. As another example, the input/output interface 318 may be means for interfacing with a device that integrates configurations or functions for both input and output, such as a touchscreen. In FIG. 3, the input/output device 320 is illustrated as not being included in the user terminal 210, but is not limited thereto and may be configured as a single device with the user terminal 210. Also, the input/output interface 338 of the information-processing system 230 may be means for interfacing with an input or output device (not illustrated) connected to or included in the information-processing system 230. Although the input/output interfaces 318, 338 are illustrated as separate elements from the processors 314, 334 in FIG. 3, they are not limited thereto and may be configured so as to be included in the processors 314, 334.

The user terminal 210 and the information-processing system 230 may include more components than those illustrated in FIG. 3. However, it is unnecessary to clearly illustrate most conventional technical components. In an example, the user terminal 210 may be implemented so as to include at least some of the input/output devices 320 described above. Further, the user terminal 210 may further include additional components such as a transceiver, a GPS module, a camera, various sensors, or a database. For example, when the user terminal 210 is a smartphone, the user terminal 210 may include components generally included in smartphones and may be implemented so as to further include various components such as an accelerometer, a gyroscope, a microphone module, a camera module, various physical buttons, buttons using a touchscreen, input/output ports, or a vibrator for vibration.

According to an example, the processor 314 of the user terminal 210 may be configured so that an application or web-browser application that provides information associated with a real-time data for a specific data item, generates a chart including information associated with the real-time data, and outputs the generated chart operates. At this time, program code associated with the application may be loaded into the memory 312 of the user terminal 210. While the application operates, the processor 314 of the user terminal 210 may receive information or data provided from the input/output device 320 through the input/output interface 318 or receive information or data from the information-processing system 230 through the communication interface 316, may process the received information or data, and may store the information or data in the memory 312. Additionally, such information or data may be provided to the information-processing system 230 through the communication interface 316.

While the application operates, the processor 314 may receive voice data, text, images, or video inputted or selected through an input device such as a touchscreen, a keyboard, a camera including an audio sensor or an image sensor, or a microphone through the input/output interface 318, and may store the received voice data, text, images, or video in the memory 312 or may provide the same to the information-processing system 230 through the communication interface 316 and the network 220. In an example, the processor 314 may receive a user input selecting a graphic object displayed on a display through the input device, and may provide data/requests corresponding to the received user input to the information-processing system 230 through the network 220 and the communication interface 316. For example, the processor 314 may receive a user input selecting a specific data item among identifiers associated with complex real-time data items that the user holds, and may request information associated with a real-time data for the selected specific data item from the information-processing system 230. The information-processing system may transmit information associated with a real-time data for the selected specific data item to the user terminal 210, and the user terminal may retrieve information associated with a real-time data for the selected specific data item, generate a chart including information associated with the real-time data, and output the generated chart through a user interface.

The processor 314 of the user terminal 210 may output information or data by transmitting the information or data to the input/output device 320 through the input/output interface 318. For example, the processor 314 of the user terminal 210 may output processed information or data through an output device such as a display (touchscreen or display) or a voice-output device (speaker).

The processor 334 of the information-processing system 230 may be configured so as to manage, process, or store information or data received from a plurality of user terminals 210 or a plurality of external systems. Information or data processed by the processor 334 may be provided to the user terminal 210 through the communication interface 336 and the network 220. For example, the processor 334 may receive, from the user terminal 210, user input selecting a specific data item among identifiers associated with complex real-time data items that the user holds, and may provide information associated with a real-time data for the selected specific data item to the user terminal 210 through the communication interface 336 and the network 220.

FIG. 4 is a diagram illustrating an example of user interfaces 400a and 400b for selecting a particular identifier among identifiers associated with complex real-time data items that the user holds. In FIG. 4, as a specific example, the user interfaces 400a, 400b configured to select a particular item among underlying asset items associated with an option product is illustrated. For example, the real-time data items may include the option product, and an identifier may include a symbol of the underlying asset.

In an example, a processor (e.g., at least one processor of a user terminal or the information-processing system) may output, as at least part of the first user interface 400a, a list of identifiers associated with complex real-time data items that the user holds. Through the list of identifiers, the user may check, for each identifier, a symbol name, expected value for each held real-time data that the user is associated with for each identifier, and current value for each held real-time data that the user is associated with for each identifier.

With reference to the first user interface 400a, the processor may output, as at least part of the first user interface 400a, a list of underlying-asset symbols associated with option products that the user holds. Through the list of underlying-asset symbols, the user may check, for each underlying-asset symbol, a symbol name, expected profit for each held option product that the user holds for each underlying-asset symbol, and current profit for each held option product that the user holds for each underlying-asset symbol.

In an example, the user may select at least one specific identifier for which the user intends to retrieve information associated with a real-time data from the list of identifiers. In response to receiving the user input selecting the specific identifier, the processor may output summary information associated with a real-time data for the selected specific identifier.

With reference to the first user interface 400a and the second user interface 400b, the user may select at least one specific underlying-asset symbol 410 for which the user intends to retrieve information associated with an option product from the list of underlying-asset symbols. In response to receiving the user input selecting the specific underlying-asset symbol 410, the processor may output summary information 420 associated with an option product for the selected specific underlying-asset symbol 410.

In an example, the processor may output the summary information associated with a real-time data for the selected specific identifier.

With reference to the second user interface 400b, the processor may output, as at least part of the second user interface 400b, the summary information 420 associated with an option product for the selected specific underlying-asset symbol 410.

In an example, the summary information associated with a real-time data may include information on a held real-time data that the user holds with respect to the specific identifier. As concrete examples, the summary information associated with a real-time data may include the identifier name of the specific identifier associated with the held real-time data that the user holds, a type of the real-time data (e.g., a category of the real-time data), expiration-date information of the held real-time data, value information of the held real-time data, quantity information of the held real-time data, information on expected value of the held real-time data, and the like, but is not limited thereto.

With reference to the second user interface 400b, the summary information 420 associated with an option product may include information on a held option product that the user holds with respect to the specific underlying-asset symbol 410. As concrete examples, the summary information 420 associated with an option product may include the symbol name of the specific underlying-asset symbol 410 associated with the held option product that the user holds, a type of the held option product (e.g., a call-option product or a put-option product), expiration-date information of the held option product, strike-price information of the held option product, quantity information of the held option product, information on expected profit of the held option product, and the like, but is not limited thereto.

FIG. 5 is a diagram illustrating an example in which a first chart 500 representing information associated with a real-time data is output. Referring to FIG. 5, the first chart 500 representing information associated with an option product will be described as a specific example. For example, the real-time data items may include option products, and the data item may include an underlying asset. For example, FIG. 5 illustrates an example of the first chart 500 output in the second area 130 of the user interface illustrated in FIG. 1. In an example, in response to receiving a user input selecting a “underlying asset information” tab 502 (e.g., “data item information” tab) in the first tab area 120, a processor (at least one processor of a user terminal) may output the first chart 500 as at least part of a user interface.

In an example, a first axis 520 (e.g., a horizontal axis) of the first chart 500 represents time information, and a second axis (e.g., a vertical axis) of the first chart 500 may represent price information (e.g., value information) of the specific underlying asset(e.g., data item).

In an example, the first chart 500 may provide different information for the period before the current time and the period after the current time with the current time as a reference point. For example, the first chart 500 may include value-fluctuation information of the specific underlying asset (e.g., data item) for the current time and the period before the current time, and may include information associated with a option product (e.g., real-time data) for the period after the current time. The first axis 520 of the first chart 500 may represent a flow of continuous time for the period before the current time and the period after the current time with the current time as a reference point.

In an example, the first chart 500 may include price-fluctuation information (e.g., value-fluctuation information) of the specific underlying asset (e.g., data item). Here, the price-fluctuation information (e.g., value-fluctuation information) of the specific underlying asset (e.g., data item) may correspond to the current time and the period before the current time. For example, on the first chart 500, a graph 510 showing time-based price-fluctuation information (e.g., value-fluctuation information) of the specific underlying asset (e.g., data item) may be mapped for the current time and the period before the current time.

In an example, the first chart 500 may include information associated with an option product (e.g., real time data) for the specific underlying asset (e.g., data item). The information associated with an option product (e.g., real time data) may include information on a held option product (e.g., held real time data) that the user holds with respect to the specific underlying asset (e.g., data item). Additionally, the information associated with an option product (e.g., real time data) may further include at least one of information on an interest option product (e.g., interest real time data)registered by the user with respect to the specific underlying asset (e.g., data item), price-alert information (e.g., value-alert information) for the specific underlying asset (e.g., data item), information on a profit range (e.g., value range) of the held option product (e.g., held real time data), or information on expected profit (e.g., expected value) of the held option product (e.g., held real time data), but is not limited thereto.

In an example, information associated with an option product (e.g., real time data) for the specific underlying asset (e.g., data item)may be mapped onto the first chart 500. Here, the information associated with an option product (e.g., real time data)may correspond to a period after the current time. For example, on the first chart 500, icons 530, 540, 550 representing the information associated with an option product (e.g., real time data)may be displayed for the period after the current time.

For example, information on the held option product (e.g., held real time data)may be mapped onto the first chart 500. Here, the held option product (e.g., held real time data) may be an option product (e.g., real time data) whose expiration date arrives at a time after the current time. The processor may map the information on the held option product (e.g., held real time data) based on expiration-date information of the held option product (e.g., held real time data) and strike price information (e.g., value information) of the held option product (e.g., held real time data). Specifically, the processor may map the information on the held option product (e.g., held real time data) to a position corresponding to the expiration-date information of the held option product (e.g., held real time data) on the first axis 520 of the first chart 500 and corresponding to the strike price information (e.g., value information) of the held option product (e.g., held real time data) for the specific underlying asset (e.g., data item) on the second axis of the first chart 500.

At a position where the information on the held option product (e.g., held real time data) is mapped, icons 530, 540 representing the information on the held option product (e.g., held real time data) may be displayed. Further, the icons 530, 540 representing the information on the held option product (e.g., held real time data) may display expiration-date information of the held option product, strike price information of the held option product, a type of the held option product (e.g., a call option product or a put option product), quotation information of the held option product, trading volume information (e.g., volume information) of the held option product, and the like, but are not limited thereto.

For example, information on the interest option product (e.g., interest real time data) registered by the user with respect to the specific underlying asset (e.g., data item)may be mapped onto the first chart 500. Here, the interest option product (e.g., interest real time data) may be an option product (e.g., real time data) whose expiration date arrives at a time after the current time. The processor may map the information on the interest option product (e.g., interest real time data)based on expiration-date information of the interest option product (e.g., interest real time data)data and strike price information (e.g., value information) of the interest option product (e.g., interest real time data). Specifically, the processor may map the information on the interest option product (e.g., interest real time data) to a position corresponding to the expiration-date information of the interest option product (e.g., interest real time data) on the first axis 520 of the first chart 500 and corresponding to the strike price information (e.g., value information)of the interest option product (e.g., interest real time data)for the specific underlying asset (e.g., data item)on the second axis of the first chart 500.

At a position where the information on the interest option product (e.g., interest real time data) is mapped, an icon 550 representing the information on the interest option product (e.g., interest real time data) may be displayed. Further, the icon 550 representing the information on the interest option product (e.g., interest real time data)may display expiration-date information of the interest option product, strike price information (e.g., value information)of the interest option product, a type of the interest option product (e.g., a call option product or a put option product), quotation information (e.g., prospective value information) of the interest option product, trading volume information (e.g., volume information) of the interest option product, and the like, but is not limited thereto.

For example, price-alert information (e.g., value-alert information) for the specific underlying asset (e.g., data item) registered by the user may be mapped onto the first chart 500. For instance, the user may register a price alert (e.g., value alert) so that the user receives a notification when the price (e.g., value) of the specific underlying asset (e.g., data item) reaches a particular price (e.g., value) set by the user. The processor may identify, on the second axis of the first chart 500, a price (e.g., value) corresponding to the price-alert information (e.g., value-alert information) and may display an icon 560 indicating the position corresponding to the price (e.g., value) on the first chart 500.

In an example, information on a profit range (e.g., value range) of the held option product (e.g., held real time data)or information on expected profit (e.g., expected value) of the held option product (e.g., held real time data)may be mapped onto the first chart 500. In response to receiving a user input selecting the icons 530, 540 representing the information on the held option product (e.g., held real time data)through a predefined input method (e.g., a scroll input or an axis-touch input), the processor may map information on a profit range (e.g., value range)of the held option product (e.g., held real time data)or information on expected profit (e.g., expected value) of the held option product (e.g., held real time data)corresponding to the selected icons 530, 540 onto the first chart. Examples in which information on a profit range (e.g., value range)or information on expected profit (e.g., expected value) of the held option product (e.g., held real time data)is mapped are described in detail with reference to FIG. 6.

In an example, in response to receiving, with respect to each axis direction of the first chart, an input of a predefined method (e.g., a scroll input, an axis-touch input, or a predefined shortcut-key input), the processor may adjust a depth of the first chart 500. Here, the depth may denote a range or interval of data that may be displayed along each axis direction of the first chart 500. Accordingly, in response to receiving, with respect to at least one of the first axis direction 520 or the second axis direction of the first chart 500, an input of the predefined method, the processor may change positions, kinds, and/or quantities of the icons 530, 540, 550, 560 displayed on the first chart 500.

Although FIG. 5 describes an example in which information associated with an option product (e.g., real time data)corresponding to a period after the current time is mapped onto the first chart 500, information associated with an option product (e.g., real time data) corresponding to the current time and the period before the current time may, of course, also be mapped onto the first chart 500. For example, on the first chart 500, information associated with an option product (e.g., real time data), among option products (e.g., complex real time data) items that the user previously held in the past, that was traded or was not traded may also be mapped.

Through such a configuration, the graph 510, which shows time-based price-fluctuation information (e.g., value-fluctuation information) of the specific underlying asset (e.g., data item), and information on the held option product (e.g., held real time data)that the user holds may be mapped onto a single chart, thereby enabling the user to intuitively compare a price trend of the specific underlying asset (e.g., data item)with strike price information (e.g., value information)of the held option product (e.g., held real time data)without switching or leaving a screen.

FIG. 6 is a diagram illustrating examples in which information on a value range or information on expected value of a held real-time data is mapped onto first charts 600a, 600b, 600c. Referring to FIG. 6, the first charts 600a, 600b, 600c onto which information on a profit range of a held option product or information on an expected profit is mapped will be described as a specific example. For example, the real-time data items may include option products, and the data item may include an underlying asset.

A processor may output the first charts 600a, 600b, 600c as at least part of a user interface. A first axis (e.g., a horizontal axis) of the first charts 600a, 600b, 600c represents time information, and a second axis (e.g., a vertical axis) of the first charts 600a, 600b, 600c represents price information (e.g., value information)of the specific underlying asset (e.g., data item).

In an example, the first charts 600a, 600b, 600c may include price-fluctuation information (e.g., value-fluctuation information) of the specific underlying asset (e.g., data item)for the current time and the period before the current time and information associated with an option product (e.g., real time data) for the period after the current time. As a concrete example, on the first charts 600a, 600b, 600c, a graph 610 showing price-fluctuation information (e.g., value-fluctuation information) of the specific underlying asset (e.g., data item)for the current time and the period before the current time may be mapped. Further, on the first charts 600a, 600b, 600c, icons 620, 622, 624, 630, 632, 634, 644 representing information associated with an option product (e.g., real time data) for the period after the current time may be displayed.

In an example, the information associated with an option product (e.g., real time data)may include information on a held option product (e.g., held real time data)that the user holds with respect to the specific underlying asset (e.g., data item). Further, the information on the held option product (e.g., held real time data)may include information on a profit range (e.g., value range)of the held option product (e.g., held real time data)or information on expected profit (e.g., expected value) of the held option product (e.g., held real time data). In response to receiving a user input selecting the icons 620, 630 representing the information on the held option product (e.g., held real time data)through a predefined input method (e.g., a scroll input or an axis-touch input), the processor may map, onto the first chart, information on a profit range (e.g., value range)or information on expected price (e.g., expected value) of the held option product (e.g., held real time data)corresponding to the selected icons 620, 630.

With reference to the first chart 600a according to a first example, in response to receiving a user input selecting an icon 620 representing information on a first held option product (e.g., first held real time data), the processor may map information on a profit range (e.g., value range)of the first held option product (e.g., first held real time data)onto the first chart 600a. Here, the first held option product (e.g., first held real time data) may be a put-option product.

In an example, the processor may identify, on the second axis of the first chart 600a, a price (e.g., value) of the specific underlying asset (e.g., data item) (e.g., BEP $123.00, referred to as a “first_1 value”) corresponding to a break-even point (e.g., predetermined point) of the first held option product (e.g., first held real time data). Further, the processor may display, on the first chart 600a, an icon 622 indicating the identified first_1 value.

Additionally, the processor may display, on the first chart 600a, regions corresponding to a value higher than the first_1 value and a value lower than the first_1 value as being distinguished from each other. As a concrete example, when the first held option product (e.g., first held real time data) is a a particular category of real-time data (e.g., put option product), a region corresponding to a price (e.g., value)lower than the first_1 value, which corresponds to the break-even point (e.g., predetermined point), may be emphasized on the first chart 600a as a profit range (e.g., value range)of the first held option product (e.g., first held real time data).

In an example, in response to receiving a user input selecting the icon 620 representing the information on the first held option product (e.g., first held real time data), the processor may map information on expected profit (e.g., expected value) of the first held option product (e.g., first held real time data)onto the first chart. For example, the processor may identify or acquire expected profit (e.g., expected value) anticipated on the expiration date of the first held option product (e.g., first held real time data), and may display, on the first chart 600a, an icon 624 indicating the information on the identified or acquired expected profit (e.g., expected value).

For example, the expected profit (e.g., expected value) of the first held option product (e.g., first held real time data) may be calculated based on the price (e.g. value) of the specific underlying asset (e.g., data item)at a time of calculating the expected profit (e.g., expected value). That is, the expected profit (e.g., expected value) of the first held option product (e.g., first held real time data) may be an amount calculated on the premise that the price (e.g. value) of the specific underlying asset (e.g., data item)on the expiration date of the first held option product (e.g., first held real time data)is identical to the price (e.g. value) at the current time (e.g., at the time of calculating the expected profit). As another example, the expected profit (e.g., expected value) of the first held option product (e.g., first held real time data) may be an amount calculated on the premise that the first held option product (e.g., first held real time data) is liquidated at the current time before the expiration date of the first held option product (e.g., first held real time data) arrives.

With reference to the first chart 600b according to a second example, in response to receiving a user input selecting an icon 630 representing information on a second held option product (e.g., second held real time data), the processor may map, onto the first chart 600b, information on a profit range (e.g., value range)of the second held option product (e.g., second held real time data) and/or information on expected value of the second held option product (e.g., second held real time data). Here, the second held option product (e.g., second held real time data) may be a different category of real-time data (e.g., call option product).

In this case, the processor may identify, on the second axis of the first chart 600b, a price (e.g., value) of the specific data item (e.g., BEP $118.69, referred to as a “first_2 value”) corresponding to a break-even point (e.g., predetermined point) of the second held option product (e.g., second held real time data) and may display, on the first chart 600b, an icon 632 indicating the identified first_2 value. Further, the processor may emphasize, on the first chart 600b, a region corresponding to a price (e.g., value) higher than the first_2 value as a profit range (e.g., value range) of the second held option product (e.g., second held real time data) so that the region corresponding to a price (e.g., value) higher than the first_2 value and the region corresponding to a price (e.g., value) lower than the first_2 value are distinguished from each other. Additionally, the processor may identify or acquire expected profit (e.g., expected value) anticipated on the expiration date of the second held option product (e.g., second held real time data), and may display, on the first chart 600b, an icon 634 indicating the information on the identified or acquired expected profit (e.g., expected value).

With reference to the first chart 600c according to a third example, in response to receiving user inputs selecting the icon 620 representing information on the first held option product (e.g., first held real time data) and the icon 630 representing information on the second held option product (e.g., second held real time data), the processor may map, onto the first chart 600c, information on profit ranges (e.g., value ranges) of the first held option product (e.g., first held real time data) and the second held option product (e.g., second held real time data). Additionally and/or alternatively, in response to receiving user inputs selecting the icons 620, 630, the processor may map, onto the first chart 600c, information on expected profits (e.g., expected values) of the first held option product (e.g., first held real time data) and the second held option product (e.g., second held real time data). Here, the first held option product (e.g., first held real time data) may be a first category of real-time data (e.g., put option product) and the second held option product (e.g., second held real time data) may be a second category of real-time data (e.g., put option product). Further, the first held option product (e.g., first held real time data) and the second held option product (e.g., second held real time data) may be option products (e.g., complex real-time data items) items having the same expiration date.

In this case, the processor may identify, on the second axis of the first chart 600c, the first_1 value (e.g., BEP $123.00) corresponding to the break-even point (e.g., predetermined point)of the first held option product (e.g., first held real time data) and the first_2 value (e.g., BEP $118.69) corresponding to the break-even point (e.g., predetermined point)of the second held option product (e.g., second held real time data), and may display, on the first chart 600c, the icon 622 indicating the first_1 value and the icon 632 indicating the first_2 value. Further, the processor may emphasize, on the first chart 600c, a region corresponding to a price (e.g., value) lower than the first_1 value and higher than the first_2 value as a profit range (e.g., value range)for the first held option product (e.g., first held real time data) and the second held option product (e.g., second held real time data).

Additionally, the processor may identify or acquire information on total expected profit (e.g., expected value) obtained by summing expected profit (e.g., expected value) anticipated on the expiration date of the first held option product (e.g., first held real time data) with expected profit (e.g., expected value) anticipated on the expiration date of the second held option product (e.g., second held real time data), and may display, on the first chart 600c, an icon 644 indicating the information on the identified or acquired total expected profit (e.g., expected value).

In an example, at least one of a price (e.g., value) corresponding to the break-even point (e.g., predetermined point) of the held option product(e.g., the first_1 value or the first_2 value) and expected profit (e.g., expected value) of the held option product (e.g., held real time data) may be calculated by at least one processor of an information-processing system (e.g., 230 of FIG. 3) and received by the user terminal, but is not limited thereto. For example, both the price (e.g., value) corresponding to the break-even point (e.g., predetermined point) of the held option product (e.g., held real time data) and the expected profit (e.g., expected value) of the held option product (e.g., held real time data) may be calculated by at least one processor of the user terminal.

Through such a configuration, information on expected profit (e.g., expected value) of a held option product (e.g., held real time data) that the user holds may be output on the first chart, or profit and loss ranges of the held option product (e.g., held real time data) may be displayed as being distinguished from each other, whereby the user may readily monitor information on the held option product (e.g., held real time data).

FIG. 7 is a diagram illustrating an example of a user interface 700 in which the first chart and a second chart are output. For example, FIG. 7 illustrates an example of the user interface 700 output in response to receiving a user input selecting a “chart comparison” tab in the second tab area 140 of FIG. 1.

A processor (at least one processor of a user terminal) may output a first chart as at least part of the user interface 700. For example, the first chart may be output in a first area 710 of the user interface 700. Here, a first axis (e.g., a horizontal axis) of the first chart represents time information, and a second axis (e.g., a vertical axis) of the first chart may represent price information (e.g., value information) of the specific underlying asset (e.g., data item).

In an example, the first chart may include price-fluctuation information (e.g., value-fluctuation information) of the specific underlying asset (e.g., data item). Here, the price-fluctuation information (e.g., value-fluctuation information) of the specific underlying asset (e.g., data item)may correspond to the current time and the period before the current time. For example, on the first chart, a graph showing price-fluctuation information (e.g., value-fluctuation information) of the specific underlying asset (e.g., data item)for the current time and the period before the current time may be mapped.

The processor may output a second chart as at least part of the user interface 700. For example, the second chart may be output in a second area 720 of the user interface 700. Here, a third axis (e.g., a horizontal axis) of the second chart represents time information, and a fourth axis (e.g., a vertical axis) of the second chart may represent price information (e.g., value information) of an option product (e.g., real time data) for the specific underlying asset (e.g., data item).

In an example, the second chart may include price-fluctuation information (e.g., value-fluctuation information) of an option product (e.g., real time data) for the specific underlying asset (e.g., data item). Here, the price-fluctuation information (e.g., value-fluctuation information) of the option product (e.g., real time data) may correspond to the current time and the period before the current time. For example, on the second chart, a graph showing price-fluctuation information (e.g., value-fluctuation information) of the option product (e.g., real time data) for the current time and the period before the current time may be mapped.

In an example, the first chart and the second chart may be output in adjacent positions. For example, the processor may generate the first chart and the second chart, and may output the generated first chart and the generated second chart as at least part of a user interface. At this time, the second chart may be output in a position adjacent to the first chart. As a concrete example, the first chart and the second chart may be output in adjacent positions so as to share the same time axis 730. In another example, one of the first chart and the second chart may be output so as to overlap or be superimposed on at least part of the other chart.

In FIG. 7, the first area 710 in which the first chart is output is illustrated as being arranged at an upper portion of the user interface 700, and the second area 720 in which the second chart is output is illustrated as being arranged at a lower portion of the first area 710, but positions or relative positions of the first area 710 and the second area 720 may vary depending on design of the user interface.

In an example, since the first chart and the second chart are configured so as to share the same time axis 730, the first axis of the first chart and the third axis of the second chart may represent the same time range. That is, the first chart and the second chart may represent information of the same time period. In other words, the first chart and the second chart may be synchronized so as to represent information of the same time period, and, accordingly, data output on the first chart and data output on the second chart may be interlinked with each other. In another example, at least part of the first axis, which is the horizontal axis of the first chart, and at least part of the third axis, which is the horizontal axis of the second chart, may overlap or include one another. That is, at least part of the first chart and at least part of the second chart may represent information of the same time period. In other words, the first chart and the second chart may both include information on a first time range. The first chart and the second chart may be synchronized so as to represent information on the first time range, and, accordingly, data output on the first chart and data output on the second chart may be interlinked with each other with respect to the first time range.

In an example, the user may adjust a depth of data displayed on the time axis 730. At this time, since the first chart and the second chart are configured so as to share the same time axis 730, information mapped on the first chart and information mapped on the second chart may be interlinked with each other and may change together.

As a concrete example, in response to receiving, with respect to the time axis 730 direction, an input of a predefined method (e.g., a scroll input, an axis-touch input, or a predefined shortcut-key input), the processor may adjust a range or interval of time information displayed on the time axis 730. As another example, in response to receiving, through a third area 740 of the user interface 700, a user input for setting a time range of data output on the first chart and the second chart, the processor may adjust a range or interval of time information displayed on the time axis 730.

In an example, in a fourth area 750 of the user interface 700, information on current profit (e.g., current value) or current profit ratio (e.g., current value ratio)with respect to the held option product (e.g., held real time data) that the user holds with respect to the specific underlying asset (e.g., data item)may be output. Additionally or alternatively, information on expected profit (e.g., expected value) or expected profit ratio (e.g., expected value ratio)anticipated on the expiration date of the held option product (e.g., held real time data) may be output in the fourth area 750 of the user interface 700.

Through such a configuration, since the first chart and the second chart are output on a single screen, the user may easily compare price-fluctuation information (e.g., value-fluctuation information) of the specific underlying asset (e.g., data item)with price-fluctuation information (e.g., value-fluctuation information) of an option product (e.g., real time data) for the underlying asset (e.g., data item)without switching or leaving a screen.

Further, since the first chart and the second chart are output in adjacent positions and are synchronized based on the same time axis 730, the user may readily grasp price-fluctuation trends in the same time period with respect to the specific underlying asset (e.g., data item)and an option product (e.g., real time data) associated with the specific underlying asset (e.g., data item).

FIG. 8 is a diagram illustrating examples of user interfaces 800a, 800b in which information on a plurality of posts associated with a specific data item is output. For example, FIG. 8 illustrates examples of a first user interface 800a and a second user interface 800b output in response to a “community” tab 802 in the first tab area 120 of FIG. 1 being selected.

In the first user interface 800a, a first chart representing value-fluctuation information of the specific data item may be output. When the data item represents an underlying asset, the first chart may represent price-fluctuation information of the specific underlying asset. For example, a first axis 820 (e.g., a horizontal axis) of the first chart represents time information, and a second axis (e.g., a vertical axis) may represent value information of the specific data item. Here, the value-fluctuation information of the specific data item may correspond to the current time and the period before the current time. For example, on the first chart, a graph 810 showing time-based value-fluctuation information of the specific data item may be mapped for the current time and the period before the current time.

In an example, the first chart may include information associated with a real-time data for the specific data item. The information associated with a real-time data may include information on posts associated with a real-time data. Here, the information on posts may include information corresponding to at least one of the current time, the period before the current time, and the period after the current time.

In an example, the processor may map information on posts onto the first chart. For example, the information on posts may include time information targeted by each post. The processor may map, onto the first chart, information on a plurality of posts, each targeting respective items of time information on the first axis of the first chart.

As concrete examples, to a first time point (e.g., 6/7) on the first axis, information on a plurality of posts targeting the first time point may be mapped, and to a second time point (e.g., 6/28) on the first axis, information on a plurality of posts targeting the second time point may be mapped. As other examples, to the first time point (e.g., 6/7) on the first axis, information on a plurality of posts targeting a period that includes the first time point (e.g., a period from 5/31 to 6/7) may be mapped, and to the second time point (e.g., 6/28) on the first axis, information on a plurality of posts targeting a period that includes the second time point (e.g., a period from 6/21 to 6/28) may be mapped.

In an example, the information on a plurality of posts may include information on a number of posts targeting each of the plurality of items of time information. The information on the number of posts may be mapped onto the first chart. For example, an icon 830 representing the information on the number of posts may be visually displayed at a position corresponding to each of the plurality of items of time information on the first chart.

In an example, the information on the number of posts may be differentially displayed through the form, size, or color of the icon 830 representing the information on the number of posts. As a concrete example, the larger the number of posts, the larger the icon representing the information on the number of posts may be displayed, and the smaller the number of posts, the smaller the icon may be displayed. Additionally or alternatively, a numerical value corresponding to the number of posts may be displayed on the icon 830 representing the information on the number of posts. Accordingly, the number of posts may be intuitively compared by time point.

With reference to the second user interface 800b, a plurality of posts 840, 850, 860 with respect to the specific data item shared by a plurality of users may be output in the form of a list. Each of the plurality of posts 840, 850, 860 may include information 842, 852, 862 on the plurality of posts. The information 842, 852, 862 on the plurality of posts may include at least one of a specific time information targeted by each of the plurality of posts, category information, or value-fluctuation prediction information of the specific data item associated with each of the plurality of posts. In an example, category information may denote information on a category classified according to the content of a post, and the category information may include a question category, a material category, an analysis category, and the like, but is not limited thereto.

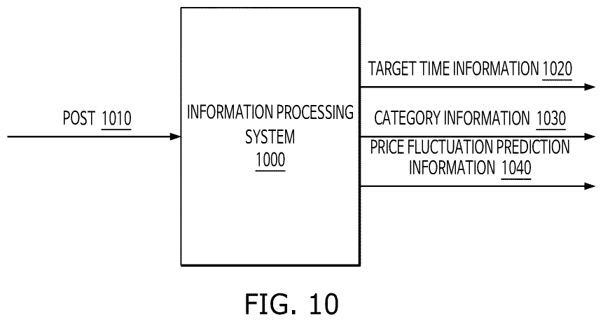

The information 842, 852, 862 on the plurality of posts may be tagged to each of the plurality of posts. In an example, the information 842, 852, 862 on the plurality of posts may be directly tagged by a user sharing the post. Alternatively, the information 842, 852, 862 on the plurality of posts may be identified or extracted from each of the plurality of posts by the processor and then tagged. An example in which the information 842, 852, 862 on the plurality of posts is identified or extracted from a post is described in detail with reference to FIG. 10.

In an example, the user may set category information of posts to be output in the second user interface 800b through a first drop-down box 870. In response to receiving a user input selecting a specific category, the processor may filter and output only posts corresponding to the specific category. The user may also set a sorting method of posts to be output in the second user interface 800b through a second drop-down box 880.

In an example, the user may register a post associated with a real-time data for the specific data item through the first chart. For example, the processor may receive a user input registering a post targeting specific time information among a plurality of items of time information on the first axis of the first chart. In response to receiving such a user input, the processor may map information on the registered post to the specific time information on the first chart.

In an example, the user input registering a post targeting specific time information among the plurality of items of time information on the first axis may comprise selecting the specific time information among the plurality of items of time information on the first axis and inputting registration of a post corresponding to the selected specific time information. In this case, the specific time information may be directly tagged to the post by the user sharing the post.

Additionally or alternatively, the specific time information may be automatically tagged to the post by the processor. For example, the processor may receive a user input registering a post and may identify, from the post, specific time information corresponding to the post. The processor may tag the identified specific time information to the post.

In an example, the first user interface 800a and the second user interface 800b may be output on a single screen, but are not limited thereto, and at least one of the first user interface 800a and the second user interface 800b may be output as a bottom sheet, a pop-up sheet, or the like.

Through such a configuration, the user may compare numbers of posts mapped by time point by checking information on posts mapped onto the first chart representing value-fluctuation information (e.g., price-fluctuation information) of the specific data item (e.g., specific underlying asset). Accordingly, the user may identify time points of high user interest concerning value fluctuation of the specific data item (e.g., specific underlying asset) and may obtain assistance in monitoring the specific data item (e.g., specific underlying asset) or the held real-time data (e.g., held option product) by checking information on posts corresponding to the time points.

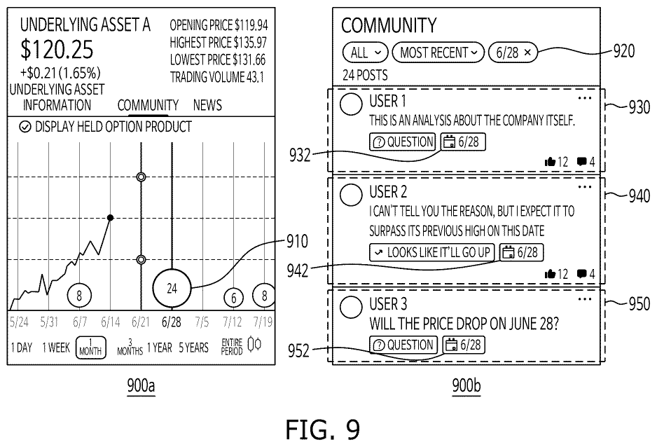

FIG. 9 is a diagram illustrating examples of user interfaces 900a, 900b in which information on posts associated with specific time information is output. Descriptions of configurations described in FIG. 8 and overlapping are omitted in FIG. 9.

With reference to the first user interface 900a, the user may selectively retrieve posts targeting specific time information. For example, in response to receiving a user input selecting specific time information among a plurality of items of time information on the first axis of the first chart, the processor may output, as at least part of a user interface, posts targeting the specific time information. The second user interface 900b illustrates an example in which posts targeting the specific time information are output.

With reference to the second user interface 900b, the processor may filter and output only posts 930, 940, 950 corresponding to specific time information 920. Each of the plurality of posts 930, 940, 950 may include a tag 932, 942, 952 corresponding to the specific time information 920 selected by the user.

Through such a configuration, since posts shared by a plurality of users are filtered and provided by time information targeted by each post, the user may selectively and easily retrieve only posts corresponding to specific time information of interest.

FIG. 10 is a block diagram for explaining an example in which information on posts is extracted from a post 1010. In an example, each of the plurality of posts shared by a plurality of users may include information on the post. The information on the post may include at least one of target time information 1020, category information 1030, and value-fluctuation prediction information 1040. Here, the target time information 1020 may denote specific time information targeted by the post.

The information on the post may be tagged to the post 1010. In an example, the information on the post may be directly tagged by the user sharing the post 1010. For example, the user may set at least one tag among target time information 1020, category information 1030, and value-fluctuation prediction information 1040 with respect to the post 1010 that the user shares.

Additionally or alternatively, the information on the post may be automatically tagged to the post 1010 based on the content of the post 1010. This may be performed by at least one processor of an information-processing system 1000, but is not limited thereto and may be performed by at least one processor of a user terminal (e.g., 210 of FIG. 2). For example, the processor may analyze dates, keywords, links, and the like included in the content of the post 1010 and may identify or extract information on the post from the post 1010.

For example, the processor may employ a text-classification model for natural-language processing to predict a category of the post 1010 from text included in the content of the post 1010 or may identify or extract information included in the content of the post 1010. Further, the processor may set, as a tag for the post 1010, at least one of the target time information 1020, the category information 1030, and the value-fluctuation prediction information 1040 identified or extracted from the post 1010.

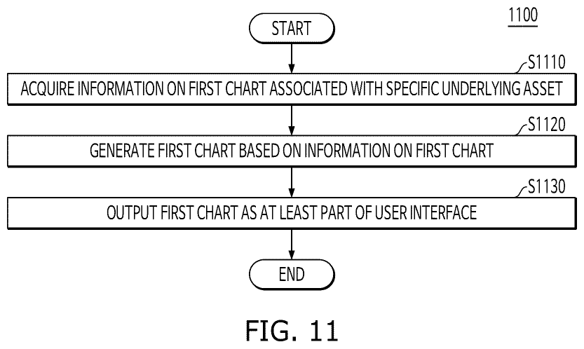

FIG. 11 is a flowchart illustrating a method 1100 for supporting analysis, display, and/or interaction with complex real-time data items. The method 1100 may be performed by at least one processor. For example, the method 1100 may be performed by at least one processor of a user terminal (hereinafter referred to as the “processor” in the description of FIG. 11).

The method 1100 may begin with the processor acquiring information on a first chart associated with a specific data item (S1110). The information on the first chart may include information associated with a real-time data for the specific data item. Here, the information associated with a real-time data may include at least one of information on a real-time data that the user holds with respect to the specific data item or information on posts associated with a real-time data for the specific data item. Additionally, the information associated with a real-time data may further include information on a real-time data registered by the user with respect to the specific data item or value-alert information registered by the user with respect to the specific data item.

The processor may generate the first chart based on the information on the first chart (S1120). Further, the processor may output the first chart as at least part of a user interface (S1130). The first chart may include value-fluctuation information of the specific data item for the current time and the period before the current time. Additionally or alternatively, the first chart may include information associated with a real-time data for the period after the current time. Here, a first axis of the first chart represents time information, and a second axis of the first chart may represent value information of the specific data item.

In an example, information on the held real-time data may be mapped onto the first chart. For example, the processor may map the information on the held real-time data to a position corresponding to expiration-date information of the held real-time data on the first axis of the first chart and corresponding to value information of the held real-time data for the specific data item on the second axis of the first chart.

In an example, information on a value range of the held real-time data may be mapped onto the first chart. For example, the processor may identify, on the second axis of the first chart, a first value of the specific data item corresponding to a predetermined point of the held real-time data. In this case, the first chart may include a first region corresponding to a value higher than the identified first value and a second region corresponding to a value lower than the first value and distinguished from the first region.

In an example, information on expected value of the held real-time data may be mapped onto the first chart. For example, the processor may identify expected value anticipated on the expiration date of the held real-time data. Here, the expected value of the held real-time data may be calculated based on a second value of the specific data item. Further, the second value may be a value of the specific data item at a time of calculating the expected value of the held real-time data. In this case, the first chart may include a region in which information on the identified expected value is displayed.

In an example, information on the real-time data may be mapped onto the first chart. For example, the processor may map the information on the real-time data to a position corresponding to expiration-date information of the real-time data on the first axis and corresponding to value information of the real-time data for the specific data item on the second axis.

In an example, value-alert information registered by the user may be mapped onto the first chart. For example, the processor may identify, on the second axis of the first chart, a third value corresponding to the value-alert information registered by the user. In this case, the first chart may display a position corresponding to the identified third value.

In an example, information on posts associated with a real-time data for the specific data item may be mapped onto the first chart. For example, the processor may map, onto the first chart, information on a plurality of posts, each targeting respective items of time information on the first axis of the first chart. In an example, the information on the plurality of posts may include information on a number of posts targeting each of the plurality of items of time information. In this case, the processor may map, onto the first chart, the information on the number of posts so that the information on the number of posts is visually displayed at positions corresponding to each of the plurality of items of time information on the first chart. Additionally, the information on the plurality of posts may further include at least one of category information of each of the plurality of posts or value-fluctuation prediction information of the specific data item associated with each of the plurality of posts, but is not limited thereto.

In an example, the user may register, through the first chart, posts associated with a real-time data for the specific data item. For example, in response to receiving an input registering a post targeting specific time information among a plurality of items of time information on the first axis of the first chart, the processor may map information on the registered post to the specific time information on the first chart. The input registering a post targeting specific time information among the plurality of items of time information on the first axis may comprise selecting the specific time information among the plurality of items of time information on the first axis and inputting registration of a post corresponding to the selected specific time information. Additionally or alternatively, the specific time information may be identified based on the registered post.

In FIG. 11, the method 1100 is described as being performed by at least one processor of a user terminal, but is not limited thereto, and the method 1100 may be performed by at least one processor of the user terminal or at least one processor of an information-processing system. For example, although FIG. 11 describes that at least one processor of the user terminal acquires information on the first chart, generates the first chart based on the information on the first chart, and outputs the generated first chart as at least part of a user interface, the first chart may be generated by at least one processor of the information-processing system.

The flowchart illustrated in FIG. 11 and the descriptions above are merely examples and may be implemented differently in some examples. For example, one or more steps in FIG. 11 may be omitted, orders of steps may change, steps may be performed in overlapping fashion, or one or more steps may be repeatedly performed.

The above-described method may be provided as a computer program stored on a computer-readable recording medium for execution on a computer. The medium may be one that permanently stores a computer-executable program or that temporarily stores the program for execution or download. The medium may be any single or multiple recording or storage means formed as combined hardware, and is not limited to a medium directly connected to a computer system but may exist in a distributed manner on a network. Examples of media include magnetic media such as hard discs, floppy discs, and magnetic tapes; optical recording media such as CD-ROMs and DVDs; magneto-optical media such as floptical discs; and program-instruction-stored media including ROM, RAM, or flash memory. Other examples of media may include storage media managed by app stores distributing applications or various sites or servers supplying or distributing other software.

The methods, operations, or techniques of the present disclosure may be implemented in various ways. For example, such techniques may be implemented by hardware, firmware, software, or a combination thereof. Those skilled in the art will understand that various exemplary logical blocks, modules, circuits, and algorithm steps described in connection with the present disclosure may be implemented as electronic hardware, computer software, or combinations of both.

To clearly describe the interchangeability of hardware and software, various exemplary components, blocks, modules, circuits, and steps have been described above in functional terms. Whether such functionality is implemented as hardware or software depends upon particular application-specific design constraints imposed on the overall system. Skilled artisans may implement the described functionality in varying ways for each particular application without departing from the scope of the present disclosure.

In a hardware implementation, processing units used to perform the techniques may be implemented within one or more ASICs, DSPs, digital-signal-processing devices, programmable logic devices, field-programmable gate arrays, processors, controllers, microcontrollers, microprocessors, electronic devices, other electronic units designed to perform the functions described herein, computers, or combinations thereof.

Accordingly, various exemplary logical blocks, modules, and circuits described in connection with the present disclosure may be implemented or performed within a general-purpose processor, a DSP, an ASIC, an FPGA, or another programmable logic device, discrete gate or transistor logic, discrete hardware components, or any combination thereof designed to perform the functions described herein. A general-purpose processor may be a microprocessor, but, in the alternative, the processor may be any conventionally available processor, controller, microcontroller, or state machine. The processor may also be implemented as a combination of computing devices—for example, a combination of a DSP and a microprocessor, multiple microprocessors, one or more microprocessors in conjunction with a DSP core, or any other such configuration.

In a firmware or software implementation, the techniques may be implemented with modules (e.g., procedures, functions, etc.) that perform the functions described herein. Any machine-readable medium tangibly embodying program instructions may be used for implementing the techniques described herein. For example, software codes can be stored in a memory and executed by a processor. Memory may be implemented within the processor or external to the processor, in which case it can be communicatively coupled to the processor via various means as is known in the art.

Although the examples described above have been shown and described with respect to at least one standalone computer system, the present disclosure is not limited thereto and may be implemented in any computing environment such as a network or a distributed computing environment. Further, aspects of the subject matter of the present disclosure may be implemented across multiple processing chips or devices, and storage may be affected similarly across multiple devices. Such devices may include PCs, network servers, and portable devices.

While the present disclosure has been described with reference to some examples, it will be understood by those skilled in the art that various changes in form and details may be made without departing from the scope of the invention as defined by the appended claims.

What is claimed is:

1. A method for display of complex data structures on user interfaces, the method comprising:
acquiring, by a computing device comprising one or more processors, information on a first chart associated with a specific data item, the information on the first chart comprising information associated with a real-time data item for the specific data item;
generating, by the computing device, the first chart based on the information, the first chart comprising at least one of value-fluctuation information of the specific data item for a current time and a period before the current time, or information associated with the real-time data item for a period after the current time; and
outputting, by the computing device and via a display device of the computing device, the first chart as at least part of a user interface,
wherein the information associated with the real-time data item comprises at least one of information on a held real-time data item for the specific data item or information on posts associated with a real-time data item for the specific data item.

2. The method as claimed in claim 1, wherein a first axis of the first chart represents time information and a second axis of the first chart represents value information of the specific data item, and
wherein the generating the first chart comprises mapping the information on the first axis and the second axis.

3. The method as claimed in claim 2, wherein the generating the first chart further comprises mapping information on a value range of the held real-time data item onto the first chart.

4. The method as claimed in claim 3, wherein the mapping the information on the value range comprises identifying, on the second axis, a first value of the specific data item corresponding to a predetermined point of the held real-time data item, and wherein the first chart comprises a first region corresponding to a value higher than the first value and a second region corresponding to a value lower than the first value and distinguished from the first region.

5. The method as claimed in claim 2, wherein the generating the first chart further comprises mapping information on an expected value of the held real-time data item onto the first chart.

6. The method as claimed in claim 5, wherein the mapping of the information on the expected value comprises identifying expected value anticipated on an expiration date of the held real-time data item, the expected value being calculated based on a second value of the specific data item, wherein the first chart comprises a region in which information on the expected value is displayed, and wherein the second value is a value of the specific data item at a time of calculating the expected value of the held real-time data item.

7. The method as claimed in claim 1, further comprising:
generating a second chart representing value-fluctuation information of a real-time data item for the specific data item; and
outputting the generated second chart as at least part of the user interface in a position adjacent to the first chart,
wherein a first axis of the first chart represents time information, a second axis of the first chart represents value information of the specific data item, a third axis of the second chart represents time information, and a fourth axis of the second chart represents value information of the real-time data item for the specific data item.

8. The method as claimed in claim 7, wherein a time range on the first axis of the first chart is identical to a time range on the third axis of the second chart, and
the first chart and the second chart represent information of the same time range.

9. The method as claimed in claim 1, wherein a first axis of the first chart represents time information and a second axis of the first chart represents value information of the specific data item, and
the generating the first chart comprises, in response to receiving an input registering a post targeting specific time information among a plurality of items of time information on the first axis, mapping information on the registered post to the specific time information on the first chart.

10. The method as claimed in claim 9, wherein the input registering the post targeting the specific time information comprises selecting the specific time information among the plurality of items of time information on the first axis and inputting registration of a post corresponding to the specific time information.

11. The method as claimed in claim 9, wherein the specific time information is identified based on the registered post.

12. The method as claimed in claim 1, wherein a first axis of the first chart represents time information and a second axis of the first chart represents value information of the specific data item, and the generating the first chart comprises mapping, onto the first chart, information on a plurality of posts, each targeting respective items of the time information on the first axis.

13. The method as claimed in claim 12, further comprising, in response to receiving an input selecting specific time information among a plurality of items of time information on the first axis, outputting, as at least part of the user interface, posts targeting the specific time information.

14. The method as claimed in claim 12, wherein the information on the plurality of posts comprises information on a number of posts targeting each of the plurality of items of time information, and
the mapping the information on the plurality of posts onto the first chart comprises mapping the information on the number of posts onto the first chart so that the information on the number of posts is visually displayed at positions corresponding to each of a plurality of items of time information on the first chart.

15. The method as claimed in claim 14, wherein the information on the plurality of posts further comprises at least one of category information of each of the plurality of posts or value-fluctuation prediction information of the specific data item associated with each of the plurality of posts.

16. The method as claimed in claim 1, wherein the information associated with the real-time data item further comprises information on an interest-real-time data item registered by a user with respect to the specific data item, and the generating the first chart comprises mapping the information on the interest-real-time data item onto the first chart.

17. The method as claimed in claim 16, wherein a first axis of the first chart represents time information and a second axis of the first chart represents value information of the specific data item, and wherein the mapping the information on the interest-real-time data item comprises mapping the information on the interest-real-time data item to a position corresponding to expiration-date information of the interest-real-time data item on the first axis and value information of the interest-real-time data item for the specific data item on the second axis.

18. The method as claimed in claim 1, wherein the information associated with the real-time data item further comprises value-alert information registered by a user with respect to the specific data item,
a first axis of the first chart represents time information and a second axis of the first chart represents value information of the specific data item, and
the generating the first chart comprises identifying, on the second axis of the first chart, a third value corresponding to the value-alert information, and a position corresponding to the third value is displayed in the first chart.

19. A non-transitory computer-readable recording medium storing a computer program for executing the method according to claim 1 on a computer.

20. A computing device for display of complex data structures on user interfaces, the computing device comprising:
one or more processors; and
memory storing instructions that, when executed by the one or more processors, cause the computing device to:
acquire information on a first chart associated with a specific data item, wherein the information on the first chart comprises information associated with a real-time data item for the specific data item;
generate the first chart based on the information on the first chart, wherein the first chart comprises at least one of value-fluctuation information of the specific data item for a current time and a period before the current time or information associated with the real-time data item for a period after the current time; and
output, via a display device of the computing device, the first chart as at least part of a user interface,
wherein the information associated with the real-time data item comprises at least one of information on a held real-time data item for the specific data item or information on posts associated with a real-time data item for the specific data item.
